(19) United States
(12) Patent Application Publication
(10) Pub. No.: US 2026/0027776 A1
(43) Pub. Date: Jan. 29, 2026

(54) REPLACEABLE OPTICAL MODULE AND 3D PRINTER HAVING THE SAME

(71) Applicant: Young Optics Inc., Hsinchu Science Park (TW)

(72) Inventors: CHANG-HSUAN WU, Hsinchu Science Park (TW); YU-TENG HSIUNG, Hsinchu Science Park (TW); WEI-SZU LIN, Hsinchu Science Park (TW); KO-MIN WANG, Hsinchu Science Park (TW); CHIEN-TING HUANG, Hsinchu Science Park (TW)

(21) Appl. No.: 18/782,213

(22) Filed: Jul. 24, 2024

(51) Int. Cl. B29C 64/277; B29C 64/135; B29C 64/393; B33Y 30/00; B33Y 50/02; G02B 26/08

(52) U.S. Cl. CPC B29C 64/277; B29C 64/135; B29C 64/393; B33Y 30/00; B33Y 50/02; G02B 26/0833

(57) ABSTRACT

A three-dimensional printer includes a printer main body, a printer chassis and an optical module. The printer main body includes a tank for accommodating a photosensitive material, a light-transmissive plate located at a bottom of the tank, and a printing platform adjacent to the tank. The printer chassis includes at least one base plate and defines a storage space outwardly connected to an external environment. The optical module is capable of being detached from the printer main body, the optical module is capable of being fixed in the storage space, and the optical module is capable of being entirely withdrawn from the storage space to the external environment in a single motion.

### BACKGROUND

### Field of the Invention

The invention relates to a three-dimensional printer, particularly to a three-dimensional printer having a replaceable optical module.

### Description of the Related Art

3D printers often use an ultraviolet (UV) projector to provide imaging and material curing effects. When the light valve component in the UV projector, such as a digital micromirror device (DMD), is exposed to UV light for extended periods, the micromirrors in the DMD are prone to damage. This can cause bright spots or dark areas in the image, leading to poor print quality. However, replacing the DMD requires disassembling the casing, heat dissipation module, circuit boards, and other components. After replacement, the lens must be adjusted to maintain image center alignment and resolution, making the replacement process complex and time-consuming. Moreover, when the entire UV projector of a 3D printer fails and needs replacement, variations between different projectors necessitate specialized jigs and programs to adjust the optical engine position at the printer system end. This ensures that the replacement projector achieves the specified image performance and projection area defined in the 3D printer's product specifications. Consequently, the replacement and maintenance process is not only intricate and time-consuming but also requires substantial manpower and technical expertise.

### BRIEF SUMMARY OF THE INVENTION

In order to achieve one or a portion of or all of the objects or other objects, one embodiment of the invention provides a three-dimensional printer having a replaceable optical module including a printer main body, a printer chassis, a light valve and a control circuit board. The printer main body includes a tank, a light-transmissive plate located at a bottom of the tank, and a printing platform adjacent to the tank. The printer chassis includes at least one casing and defines a storage space outwardly connected to an external environment. The control circuit board con a control circuit board controls the light valve. At least the light valve and the control circuit board are disposed on a carrier, and at least the light valve, the control circuit board and the carrier constitute the replaceable optical module capable of being detached from the printer main body. The carrier is capable of being detachably fixed to the printer chassis by a fastener, and the replaceable optical module is capable of being fixed in the storage space by the fastener and being entirely withdrawn from the storage space to the external environment.

Another embodiment of the invention provides a three-dimensional printer including a printer main body, a printer chassis and an optical module. The printer main body includes a tank for accommodating a photosensitive material, a light-transmissive plate located at a bottom of the tank, and a printing platform adjacent to the tank. The printer chassis includes at least one base plate and defines a storage space outwardly connected to an external environment. The optical module is capable of being detached from the printer main body, the optical module is capable of being fixed in the storage space, and the optical module is capable of being entirely withdrawn from the storage space to the external environment in a single motion. The optical module includes a base and an optical projection engine disposed on the base, and the base of the optical module is capable of being detachably fixed to the base plate of the printer chassis by a fastener.

Another embodiment of the invention provides a replaceable optical module for a three-dimensional printer including a light valve, a circuit board, a holder and a module interface. The replaceable optical module is capable of being fixed in a storage space in the three-dimensional printer and capable of being entirely removed from the storage space. The circuit board is electrically connected to the light valve, the holder is used for carrying the light valve, and the module interface is used for fixing the holder in the storage space.

Through the design of the embodiments, the key optical components of a 3D printer can be grouped into a replaceable optical module. Therefore, users of 3D printers can directly purchase optical modules for self-replacement, thus providing flexibility in maintenance options and enhancing maintenance convenience. Further, since the replaceable optical module itself includes a position adjustment element, the calibration of the optical projection engine or the light valve can be completed at the manufacturing stage of the replaceable optical module. Once the new optical module is installed in the 3D printer, it can provide a projection image that meets all requirements defined in the product specification, without the need of further calibration. Therefore, the maintenance and calibration procedures for the optical projection engine can be greatly simplified, reducing maintenance time and labor. Furthermore, since the replaceable optical modules are calibrated to meet the same standards (e.g., required CTF values) during manufacturing, mass-produced optical modules that have undergone standardization procedures can be directly interchanged without further calibration. Thus, users of 3D printers can directly purchase optical modules for self-replacement, providing flexibility in maintenance options and enhancing maintenance convenience.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a three-dimensional printer having a replaceable optical module according to an embodiment of the invention.

FIG. 2 shows a replaceable optical module according to an embodiment of the invention.

FIG. 3 shows a schematic diagram of an optical projection engine according to an embodiment of the invention.

FIG. 4 shows a schematic diagram of an optical module fixed on a base plate according to an embodiment of the invention.

FIG. 5 shows a schematic diagram of a replaceable optical module according to another embodiment of the invention.

FIG. 6 shows a schematic diagram of a replaceable optical module according to another embodiment of the invention.

FIG. 7 shows a schematic diagram illustrating the use of a jig for precise position adjustment of a light valve module.

FIG. 8 is a schematic diagram showing a securing mechanism for a replaceable optical module according to an embodiment of the invention.

FIG. 9 is a schematic diagram showing a securing mechanism for a replaceable optical module according to another embodiment of the invention.

FIG. 10 is a schematic diagram showing a securing mechanism for a replaceable optical module according to another embodiment of the invention.

FIG. 11 is a schematic diagram showing a securing mechanism for a replaceable optical module according to another embodiment of the invention.

FIG. 12 is a schematic diagram showing a securing mechanism for a replaceable optical module according to another embodiment of the invention.

FIG. 13 is a schematic diagram showing a securing mechanism for a replaceable optical module according to another embodiment of the invention.

FIG. 14 is a schematic diagram of a latch structure according to an embodiment of the invention.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc., as used herein, are used as labels for nouns that they precede, and do not imply any type of ordering (e.g., spatial, temporal, logical, etc.).

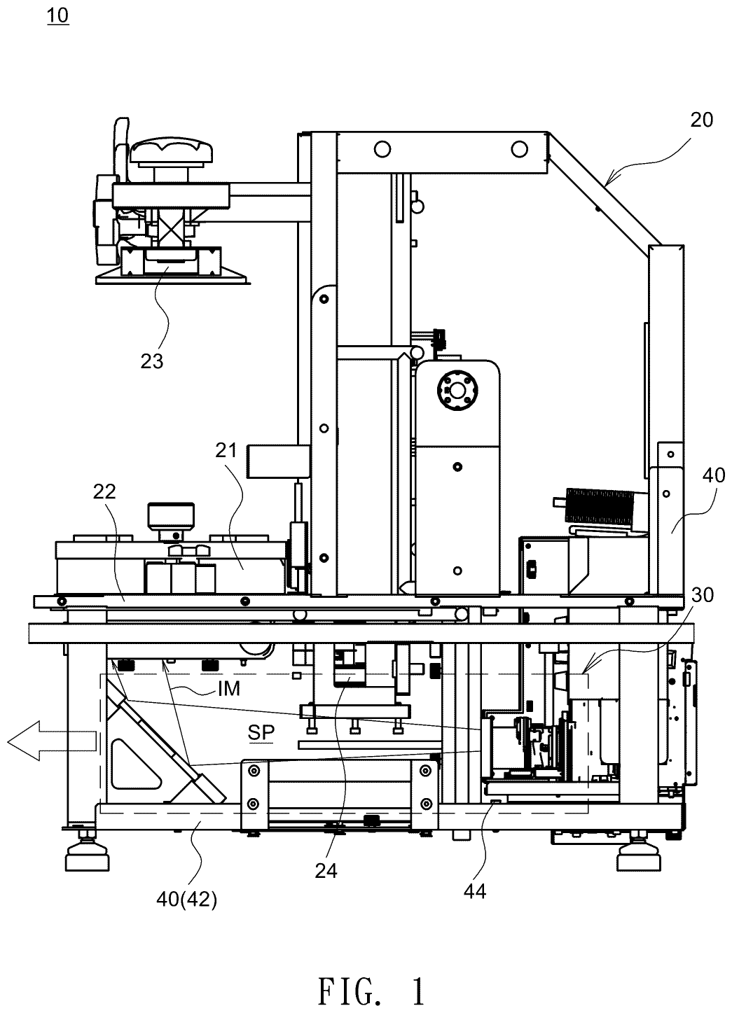

FIG. 1 shows a 3D printer having a replaceable optical module according to an embodiment of the invention. Referring to FIG. 1, in this embodiment, a three-dimensional (3D) printer 10 includes a printer main body 20, an optical module 30, and a printer chassis 40. The printer main body 20 includes a tank 21 for accommodating a photosensitive material (not shown), a light-transmissive plate 22 located at the bottom of the tank 21, a printing platform 23 adjacent to the tank 21, and a motor 24 for moving the printing platform 23. The tank 21 is used to contain a photosensitive material. The optical module 30 is capable of projecting an image beam IM, where the wavelength range of the image beam IM, such as ultraviolet, needs to match the type of the photosensitive material. The image beam IM passes through the light-transmissive plate 22 to irradiate the photosensitive material, causing it to solidify on a working surface of the printing platform 23. After the photosensitive material is cured to form a printed layer, the printing platform 23 is driven upward by the motor 24 to release the printed layer. The printing platform 23 then moves downward to be immersed in the photosensitive material again, displacing some photosensitive material in preparation for the next exposure. Repeating the above actions completes the entire printing process. The printer chassis 40 includes rigid structures such as the casing, housing, bracket and base plate, which form the printer frame and also serve to support, fix, or confine the functional components within the printer. In this embodiment, the printer chassis 40 defines a storage space SP that can be outwardly connected to an external environment, and the optical module 30 can be placed in the storage space SP and fixed to the base plate 42 of the printer chassis 40 by a fastener (such as screws 44). After removing the screws 44, the entire optical module 30 can be withdrawn from the storage space SP and pulled out of the printer chassis 40 to the external environment in a single motion, in the direction shown by the arrow in FIG. 1.

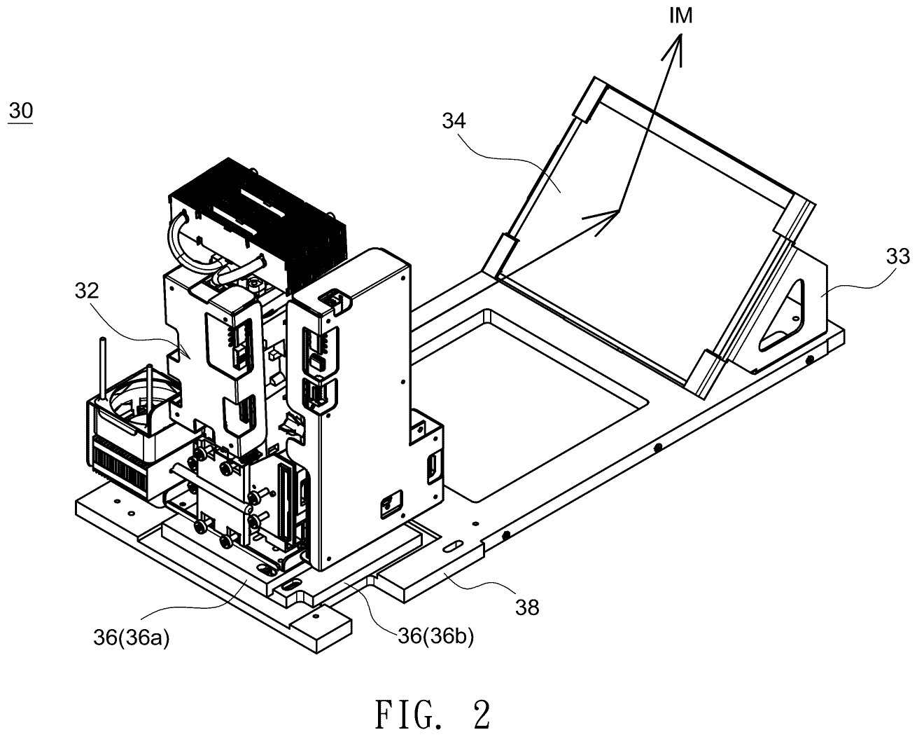

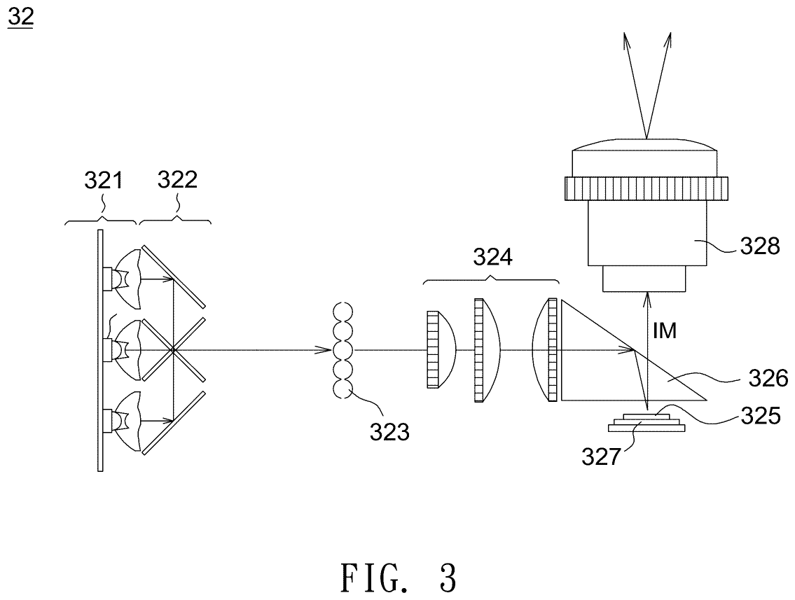

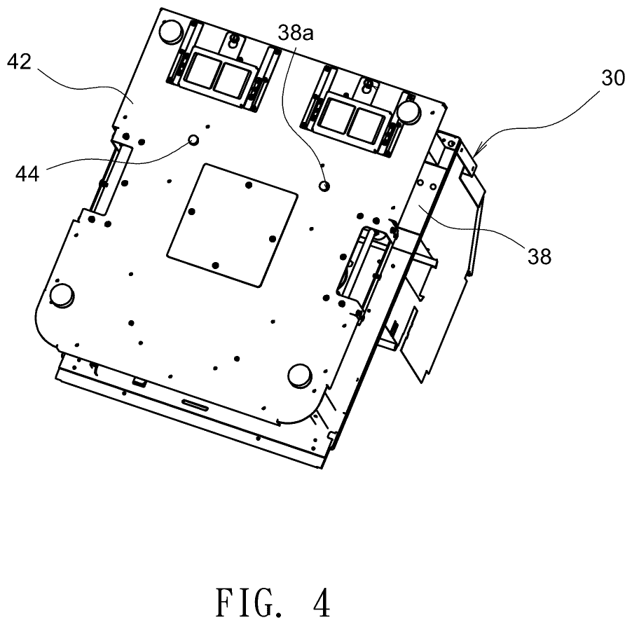

FIG. 2 shows the replaceable optical module 30 according to an embodiment of the invention. Referring to FIG. 2, the optical module 30 of this embodiment includes an optical projection engine 32, a mirror holder 33, a mirror 34, a position adjustment element 36, and a base 38. The optical projection engine 32 is disposed on the position adjustment element 36. The optical projection engine 32, the mirror holder 33, the mirror 34, and the position adjustment element 36 are all disposed on the base 38, and thus the base 38 may serve as a carrier. The base 38 is detachably fixed to the printer chassis 40. FIG. 3 shows a schematic diagram of the optical projection engine 32 according to an embodiment of the invention. As shown in FIG. 3, light beams emitted by light sources 321 (such as UV light sources) are combined by a light combining element 322 and then sequentially passe through a light homogenizing element 323, a lens group 324, and a total internal reflection prism (TIR Prism) 326. The total internal reflection prism 326 reflects the light beams to a light valve 325. In other embodiment, if the light source 321 is a single source, or if multiple light sources 321 emit light of the same wavelength range, the light combining element 322 shown in FIG. 3 can be omitted. Furthermore, the image light unit of the optical projection engine 32 is not limited to the configuration shown in FIG. 3, which includes the light sources 321 and the light valve 325. In other embodiment, the image light unit of the optical projection engine 32 may be micro light-emitting diodes (Micro LEDs). The control circuit board 327 is electrically connected to the light valve 325 and controls the light valve 325, so that the light valve 325 modulates the illumination light beams into an image beam IM. The image beam IM passes through the total internal reflection prism 326 and is projected onto an imaging platform (not shown) of the 3D printer 10 via the projection lens 328. In this embodiment, the light valve 325 is, for example, a digital micromirror device (DMD) but not limited thereto. The position adjustment element 36 is used to adjust the position of the optical projection engine 32 within the 3D printer 10. As shown in FIG. 2, in this embodiment, the position adjustment element 36 includes position calibration blocks (such as an X-axis position calibration block 36a and a Y-axis position calibration block 36b) that can adjust the position of the optical projection engine 32 in at least two different dimensions. The image beam IM emitted by the optical projection engine 32 may change direction after being reflected by the mirror 34 and be projected onto the light-transmissive plate 22. Using the position calibration blocks 36a and 36b, the position of the optical projection engine 32 can be finely adjusted. This allows for precise control over the contrast transfer function (CTF) value, projection area, light uniformity, and contrast of an projected image. Once the position adjustment element 36 has adjusted the optical projection engine 32 to allow these parameters to conform to the 3D printer's product specifications, the calibration process is complete. As shown in FIG. 4, the calibrated optical module 30 can be fixed on the base plate 42 of the printer chassis 40 by a positioning part of the base 38 (such as shaft holes 38a) and a fastener (such as screws 44). After removing the screws 44, the optical module 30 can be detached from the printer main body 20. Furthermore, when the optical module 30 is removed from the printer chassis 40, because the optical projection engine 32 is fixed on the base 38, the relative position of the light source 321 and the projection lens 328 shown in FIG. 3 remains fixed. Besides, at least the light valve 325, the control circuit board 327, the position adjustment element 36, and the base 38 will leave the printer chassis 40 together when the optical module 30 is removed from the printer chassis 40. It should be noted that the types and numbers of optical components included in the replaceable optical module 30 are merely illustrative and not restrictive, and can be varied according to different actual needs. In other embodiment, the optical module 30 may include only the base 38 and the light valve 325 and the control circuit board 327 disposed on the base 38. According to the above embodiments, since the replaceable optical module 30 includes the position adjustment element 36, and the position calibration of the optical projection engine 32 is completed at the manufacturing stage of the optical module 30, when the projection optical module of the 3D printer 10 fails or needs maintenance, the old optical module 30 can be directly removed and replaced with a new optical module 30. Therefore, the new optical module 30, once installed in the 3D printer 10, can obtain the required image performance and projection area, without the need for specialized tools and programs to adjust the position of the optical projection engine after replacing the optical projection engine in the printer system, as required by conventional designs. Therefore, the design of the above embodiments can greatly simplify the machine maintenance and calibration process and reduce maintenance time. Besides, by directly swapping out the existing optical module in the 3D printer with a new one that has already been pre-calibrated, further adjustment or calibration after installation is not needed, and thus the need to build calibration equipment and have fully skilled maintenance personnel at the printer system end can be eliminated.

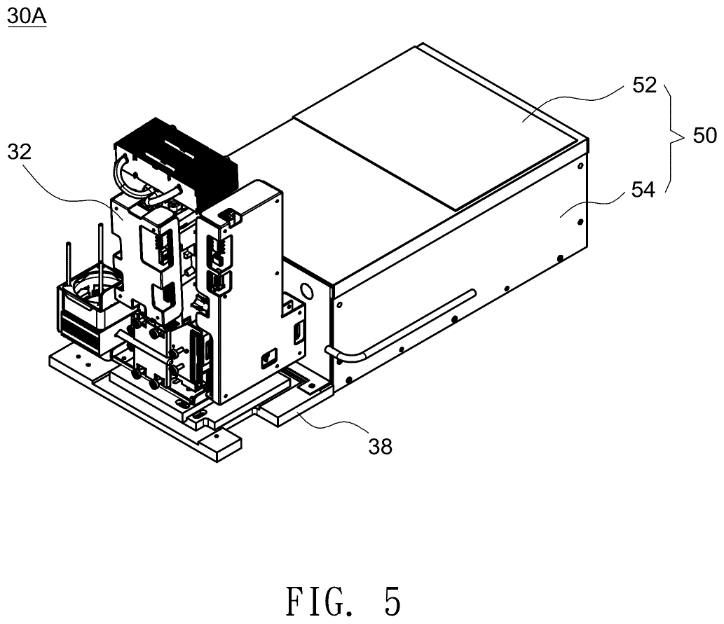

FIG. 5 shows a replaceable optical module according to another embodiment of the invention. As shown in FIG. 5, the difference between this embodiment and the embodiment of FIG. 2 is that the replaceable optical module 30A includes a dustproof component 50. The dustproof component 50 is installed on the base 38 and includes, for example, a dustproof cover 52 and a dustproof cap 54. The dustproof component 50 can cover the space between the mirror 34 and the optical projection engine 32, thereby preventing dust from entering the optical module 30A during transportation.

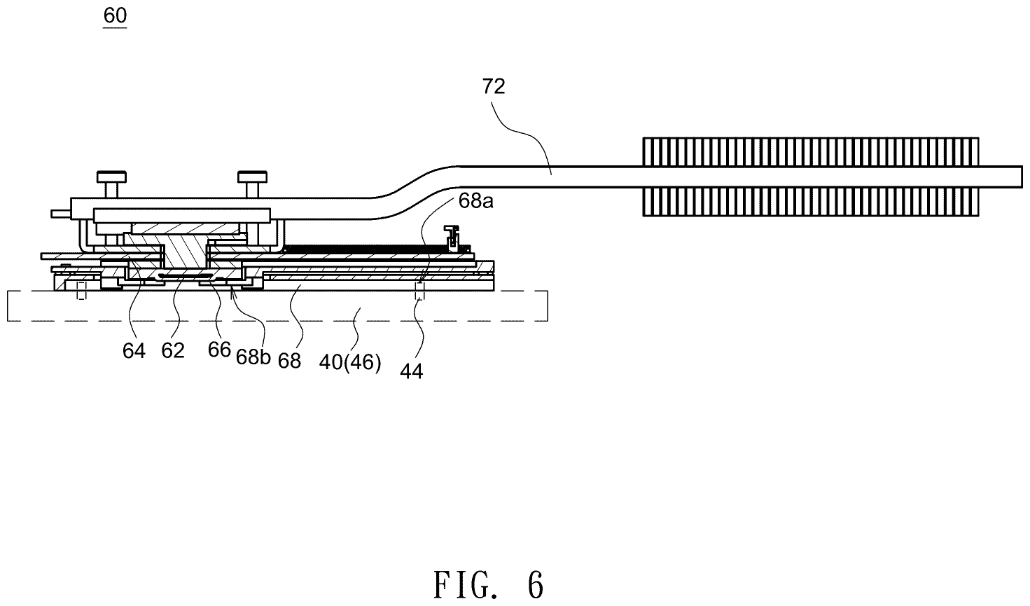

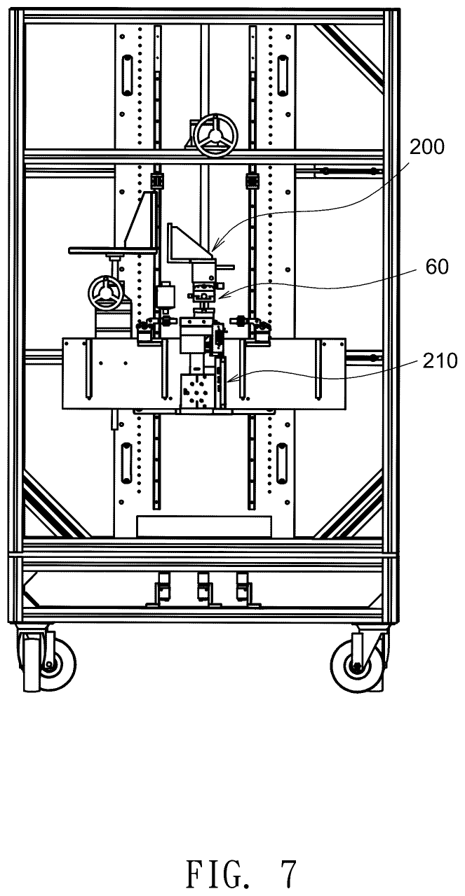

FIG. 6 shows a replaceable optical module according to another embodiment of the invention. As shown in FIG. 6, in this embodiment, the replaceable optical module for a 3D printer includes a light valve module 60. The light valve module 60 includes a light valve 62, a light valve control circuit board 64, a holder 66, and a module interface 68. The circuit board 64 is electrically connected to the light valve 62, and the light valve 62 is, for example, a digital micromirror device (DMD) but not limited thereto. The light valve 62 is disposed on the holder 66 and moves with the holder 66. By changing the position of the holder 66, the position of the light valve 62 in space can be adjusted. Therefore, the holder 66 can also serve as a position adjustment element for the light valve module 60. Furthermore, the light valve module 60 may include a heat dissipation module 72, which can be disposed on the holder 66 to enhance heat dissipation. After the light valve 62, the light valve control circuit board 64, and the heat dissipation module 72 are all assembled on the holder 66, a jig 200 shown in FIG. 7 may be used to clamp the light valve module 60 for precise position adjustment of the light valve 62. In this embodiment, as shown in FIG. 7, the light valve module 60 to be adjusted can be paired with a calibrated standard lens and a standard lower casing to form a projection image, and the projection image is captured by an image sensor 210 under the light valve module 60 to calculate the contrast transfer function (CTF) value of the projection image. When the position of the holder 66 is adjusted, different CTF values can be obtained. The holder 66 is in the correct position when the captured image's CTF value reaches the standard, indicating that the light valve 62 is correctly positioned in space, thereby completing the position adjustment. Then, the correctly positioned light valve 62 and holder 66 are fixed to the module interface 68. For example, the holder 66 may be fixed on a positioning part 68b of the module interface 68 by adhesive or welding, but not limited thereto. In this embodiment, the module interface 68 carries all components of the light valve module 60 and thus serves as a carrier. The module interface 68 can be detachably fixed to the printer chassis 40. Referring again to FIG. 6, the calibrated light valve module 60 can be fixed to a lower casing 46 of the optical engine of the printer chassis 40 by the positioning part (such as shaft holes 68a) of the module interface 68 and a fastener (such as screws 44). After removing the screws 44, the light valve module 60 can be detached from the printer chassis 40 in a single motion. According to the design of the above embodiments, the replaceable light valve module 60 includes the holder 66 that is configured to adjust the position of the light valve 62, and the position calibration of the light valve 62 is completed at the manufacturing stage of the light valve module 60. Therefore, when the light valve module of the 3D printer 10 fails or needs maintenance, the old light valve module 60 can be directly removed and replaced with a new light valve module 60. The new light valve module 60, once installed in the optical projection engine 32, can obtain the required CTF value and good image performance without the need for dismantling many components such as the housing and the circuit board, and without the need for calibrating the lens to obtain a projection image that meets the specified technical requirements when replacing a light valve, as required by conventional designs. Therefore, the design of the above embodiments may greatly simplify the process of replacing a light valve and reduce maintenance man-hours.

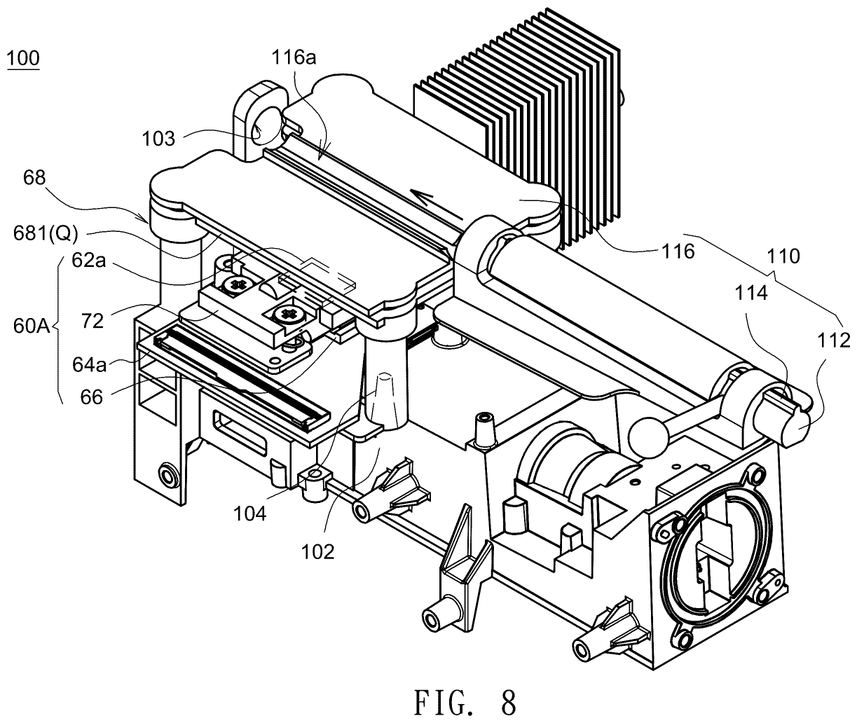

FIG. 8 is a schematic diagram showing a securing mechanism for a replaceable optical module according to an embodiment of the invention. The securing mechanism 100 is allowed to secure, for example, the replaceable optical module shown in FIG. 6 to the structural casing of the 3D printer. In this embodiment, the replaceable optical module is a DMD module 60A, but it is not limited thereto. In other embodiments, the replaceable optical module can be other image light units such as micro light-emitting diodes (Micro LEDs). As shown in FIG. 8, the DMD module 60A includes a digital micromirror device (DMD) 62a, a DMD circuit board 64a, a heat dissipation module 72, and a holder 66. The securing mechanism 100 includes a module interface 68, a structural casing 102, a positioning member 104, and a connection mechanism 110. The DMD module 60A is mounted on the module interface 68 that includes an interface structure 681. The module interface 68 contacts the structural casing 102 via the interface structure 681. The positioning member 104 is arranged between the module interface 68 and the structural casing 102 to fix the position of the module interface 68 relative to the structural casing 102. In this embodiment, the interface structure 681 can be an interface plate Q. The connection mechanism 110 is used to connect the module interface 68 to the structural casing 102. In this embodiment, the connection mechanism 110 is a latch that includes a bolt 112, an elastic element 114, and a pressure plate 116. The bolt 112 is guided by a slot 116a of the pressure plate 116 and inserted into a receptacle 103 along the direction shown by the arrow, and then the bolt 112 is rotated to compress the elastic element 114, causing the elastic element 114 to deform and press against the pressure plate 116, thereby fixing the module interface 68 to the structural casing 102 and thus securing the DMD module 60A. Furthermore, when the bolt 112 is inserted into the receptacle 103 along the direction shown by the arrow and rotates to deform the elastic element 114, the module interface 68 and the connection mechanism 110 are secured to the structural casing 102. Conversely, by rotating the bolt 112 in the reverse direction, the elastic element 114 can be released, allowing the module interface 68 and the DMD module 60A to be lifted and separated altogether from the structural casing 102.

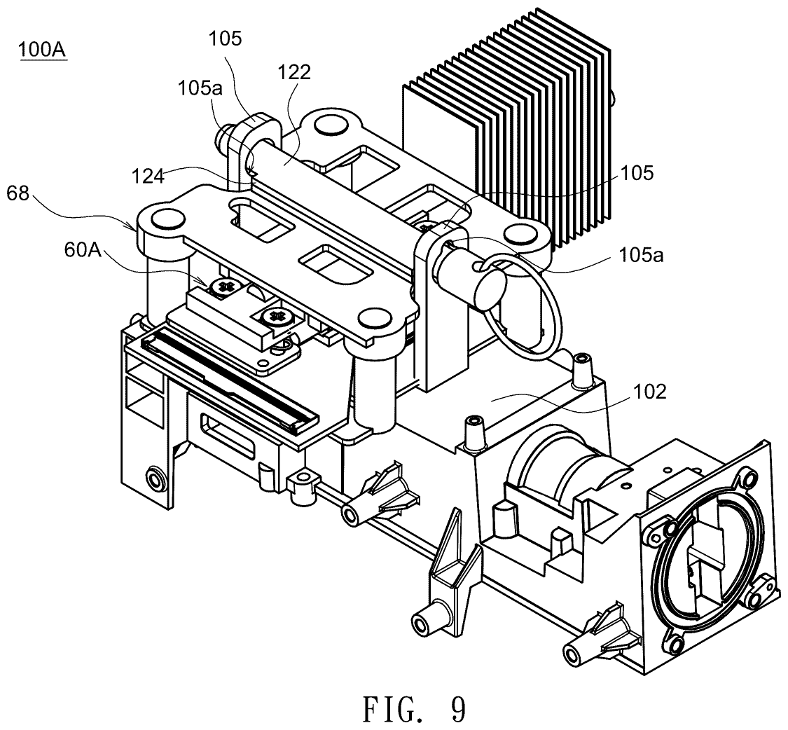

FIG. 9 is a schematic diagram showing a securing mechanism 100A for a replaceable optical module according to another embodiment of the invention. The difference between the embodiment shown in FIG. 9 and the embodiment shown in FIG. 8 lies in the different forms of connection mechanisms. As shown in FIG. 9, the connection mechanism 120 is a transverse pin, where the pin member 122 is fixed between two spaced positioning columns 105, each with a fixing hole 105a. In this embodiment, the two ends of the pin member 122 can be inserted into the two fixing holes 105a and rotated to secure, pressing the elastic element 124 to deform it, thereby fixing the module interface 68 to the structural casing 102 and thus securing the DMD module 60A.

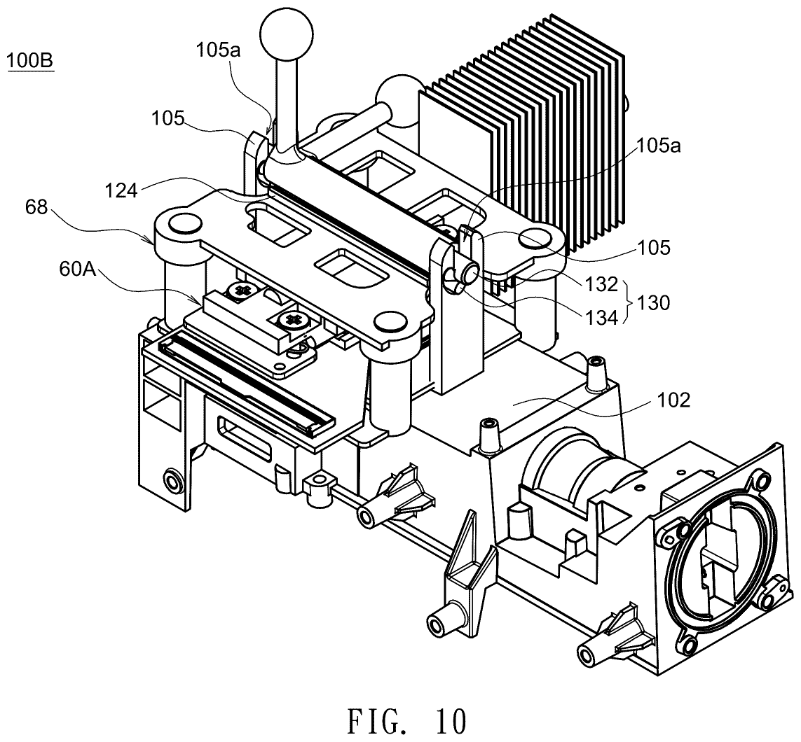

FIG. 10 is a schematic diagram showing a securing mechanism 100B for a replaceable optical module according to another embodiment of the invention. As shown in FIG. 10, the connection mechanism 130 includes a camshaft 132 and cam parts 134 connected to both ends of the camshaft 132. In this embodiment, the two ends of the camshaft 132 are respectively fitted into the two fixing holes 105a on the two positioning columns 105. By rotating the camshaft 132 by a certain angle, the elastic element 124 arranged on the module interface 68 is compressed, thereby fixing the module interface 68 to the structural casing 102 and thus securing the DMD module 60A.

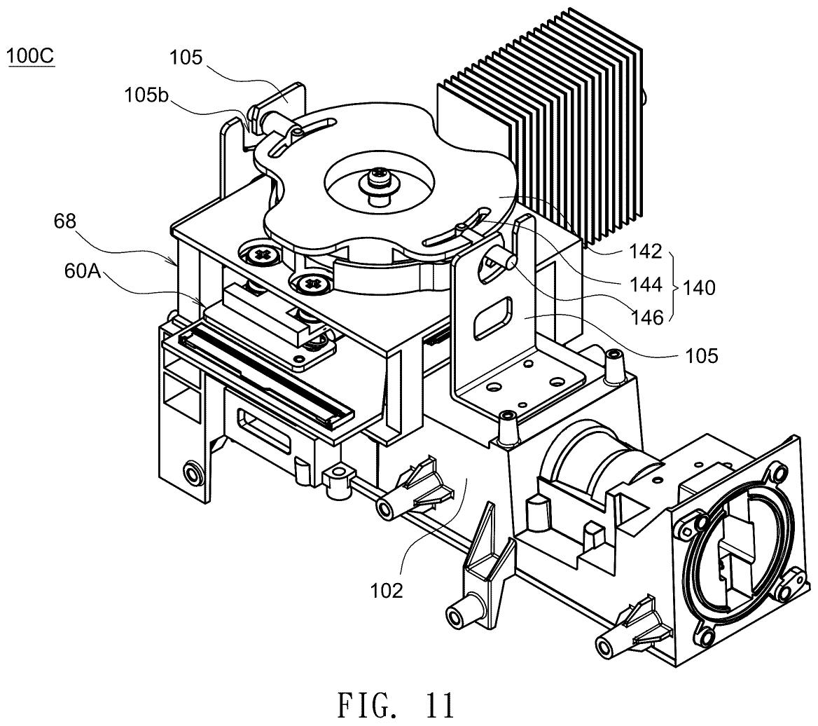

FIG. 11 is a schematic diagram showing a securing mechanism 100C for a replaceable optical module according to another embodiment of the invention. As shown in FIG. 11, the connection mechanism 140 is a rotary cover and includes a turntable 142, a fixed shaft 146, and an elastic element 144 below the turntable. In this embodiment, the fixed shaft 146 passes through the slots 105b on the two positioning columns 105 and is confined within the slots 105b, thus allowing the turntable 142 to be pivotally mounted on the two positioning columns 105. After rotating the turntable 142, the elastic element 144 (such as a spring) below the turntable 142 can be compressed, thereby fixing the module interface 68 to the structural casing 102 and thus securing the DMD module 60A.

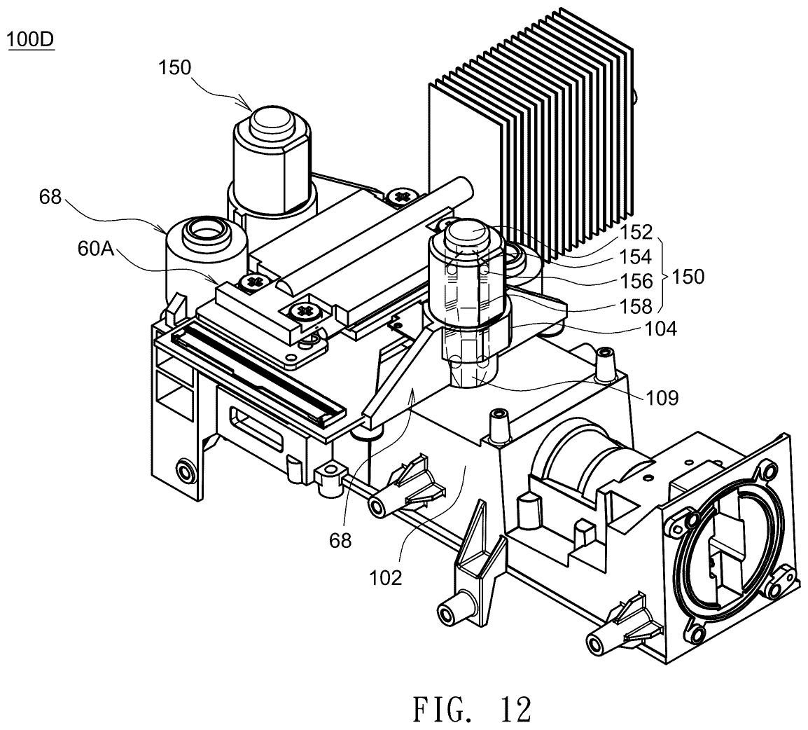

FIG. 12 is a schematic diagram showing a securing mechanism 100D for a replaceable optical module according to another embodiment of the invention. As shown in FIG. 12, the positioning member 104 is arranged between the module interface 68 and the structural casing 102 to fix the position of the module interface 68 relative to the structural casing 102. The connection mechanism 150 is a quick-release pin and includes a button 152, a pusher 154, balls 156, and springs 158. In this embodiment, when the connection mechanism 150 is inserted into the module interface 68, the pusher 154 compresses the springs 158, which, through the spring force, engages with a fixing pin 109 on the structural casing 102, thereby fixing the module interface 68 to the structural casing 102 and securing the DMD module 60A. When the button 152 is pressed, the pusher 154 is displaced, releasing the fixing pin 109 through the action of the balls 156 and the springs 158, allowing the module interface 68 and the DMD module 60A to be lifted and separated altogether from the structural casing 102.

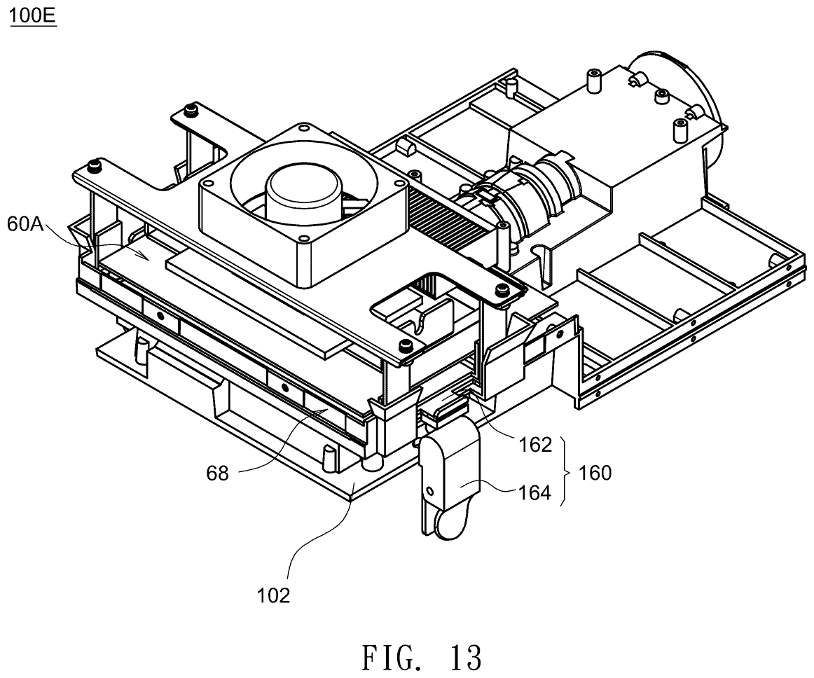

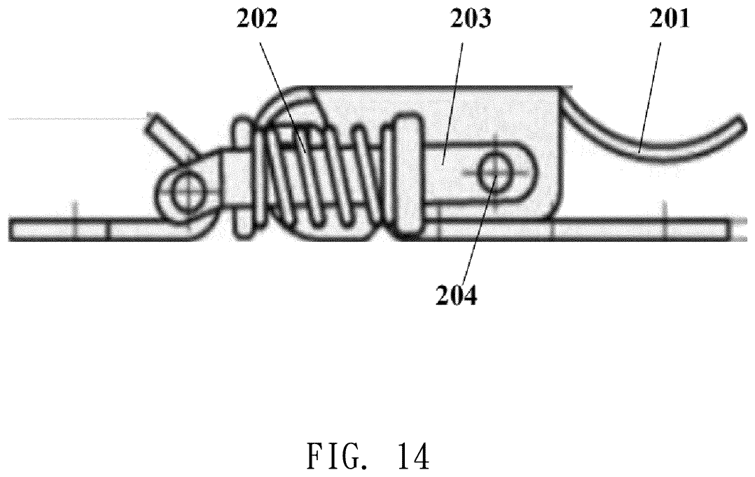

FIG. 13 is a schematic diagram showing a securing mechanism 100E for a replaceable optical module according to another embodiment of the invention. As shown in FIG. 13, the connection mechanism 160 is a fixed latch and includes a fixed part 162 and a latch part 164. The fixed part 162 can be fixed to the module interface 68, and one end of the latch part 164 can be fixed to the structural casing 102. When the latch part 164 engages the fixed part 162, pressing down the latch part 164 can tighten a deformable element (not shown), thereby fixing the module interface 68 to the structural casing 102 and securing the DMD module 60A. FIG. 14 is a schematic diagram of a latch structure according to an embodiment of the invention. As shown in FIG. 14, when an operating handle 201 is in its original position, a spring 202 is not compressed, and a support rod 203 serving as an elastic element can fully extend into the corresponding slot (not shown) to fix the module interface 68. When the operating handle 201 is pulled, the operating handle 201 can rotate around the pivot axle 204 to deform the support rod 203 and allow the support rod 203 to retract into the latch body. This action compresses the spring 202, allowing the module interface 68 and the DMD module 60A to separate from the structural casing 102.

According to the above embodiments, the key optical components of a 3D printer can be grouped into a replaceable optical module. Therefore, users of 3D printers can directly purchase optical modules for self-replacement, thus providing flexibility in maintenance options and enhancing maintenance convenience. Further, since the replaceable optical module itself includes a position adjustment element, the calibration of the optical projection engine or the light valve can be completed at the manufacturing stage of the replaceable optical module. Once the new optical module is installed in the 3D printer, it can provide a projection image that meets all requirements defined in the product specification, without further calibration. Therefore, the maintenance and calibration procedures for the optical projection engine can be greatly simplified, reducing maintenance time and labor. Furthermore, since the replaceable optical modules are calibrated to meet the same standards (e.g., required CTF values) during manufacturing, mass-produced optical modules that have undergone standardization procedures can be directly interchanged without further calibration. Thus, users of 3D printers can directly purchase optical modules for self-replacement, providing flexibility in maintenance options and enhancing maintenance convenience.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A three-dimensional printer having a replaceable optical module, comprising:
a printer main body, comprising:
a tank;
a light-transmissive plate located at a bottom of the tank; and
a printing platform adjacent to the tank;
a printer chassis including at least one casing and defining a storage space outwardly connected to an external environment;
a light valve; and
a control circuit board for controlling the light valve;
wherein at least the light valve and the control circuit board are disposed on a carrier, and at least the light valve, the control circuit board and the carrier constitute the replaceable optical module capable of being detached from the printer main body, the carrier is capable of being detachably fixed to the printer chassis by a fastener, and the replaceable optical module is capable of being fixed in the storage space by the fastener and being entirely withdrawn from the storage space to the external environment.

2. The three-dimensional printer as claimed in claim 1, wherein the optical module further includes:
a holder for carrying the light valve; and
a heat dissipation module disposed on the holder.

3. The three-dimensional printer as claimed in claim 1, wherein the optical module further includes:
a light source and a projection lens, and the light source and the projection lens are disposed on the carrier.

4. The three-dimensional printer as claimed in claim 3, wherein the optical module further includes:
a mirror disposed on the carrier.

5. The three-dimensional printer as claimed in claim 3, wherein a relative position of the light source and the projection lens remains fixed when the optical module is detached from the printer main body.

6. The three-dimensional printer as claimed in claim 3, wherein the optical module further includes:
a position adjustment element for adjusting positions of the light valve, the control circuit board, the light source, and the projection lens.

7. The three-dimensional printer as claimed in claim 6, wherein the position adjustment element includes position calibration blocks capable of adjusting the positions in at least two different dimensions.

8. The three-dimensional printer as claimed in claim 1, wherein the light valve is a digital micromirror device (DMD).

9. A three-dimensional printer, comprising:
a printer main body, comprising:
a tank for accommodating a photosensitive material;
a light-transmissive plate located at a bottom of the tank; and
a printing platform adjacent to the tank;
a printer chassis comprising at least one base plate and defining a storage space outwardly connected to an external environment; and
an optical module capable of being detached from the printer main body, the optical module is capable of being fixed in the storage space, and the optical module is capable of being entirely withdrawn from the storage space to the external environment in a single motion;
wherein the optical module includes a base and an optical projection engine disposed on the base, and the base of the optical module is capable of being detachably fixed to the base plate of the printer chassis by a fastener.

10. The three-dimensional printer as claimed in claim 9, wherein the optical projection engine includes an image light unit, and the image light unit includes micro light-emitting diodes (Micro LEDs).

11. The three-dimensional printer as claimed in claim 9, wherein the optical projection engine includes an image light unit, and the image light unit includes at least one light source and a digital micromirror device (DMD).

12. The three-dimensional printer as claimed in claim 9, wherein the optical module further includes a position adjustment element for adjusting a position of the optical projection engine in the storage space.

13. The three-dimensional printer as claimed in claim 9, wherein the optical module further includes a dustproof component disposed on the base of the optical module.

14. A replaceable optical module for a three-dimensional printer, wherein the replaceable optical module is capable of being fixed in a storage space in the three-dimensional printer and capable of being entirely removed from the storage space, and the replaceable optical module comprising:
a light valve;
a circuit board electrically connected to the light valve;
a holder for carrying the light valve; and
a module interface for fixing the holder in the storage space.

15. The replaceable optical module as claimed in claim 14, wherein the holder adjusts a position of the light valve according to a contrast transfer function (CTF) value of a projection image.

16. The replaceable optical module as claimed in claim 14, further comprising:
at least one positioning member arranged between the module interface and a structural casing of the three-dimensional printer for fixing a position of the module interface relative to a structural casing; and
a connection mechanism for connecting the module interface to the structural casing, wherein the connection mechanism has a pressing element for deforming an elastic element to fix the module interface on the structural casing by an elastic force of the elastic element.

17. The replaceable optical module as claimed in claim 16, wherein the connection mechanism is a quick-release pin including a button, a pusher, and the elastic element, the quick-release pin is capable of engaging a fixing pin on the structural casing by the elastic force of the elastic element, and the pusher is capable of being displaced to detach the quick-release pin from the fixing pin.

18. The replaceable optical module as claimed in claim 16, wherein the connection mechanism is a latch including a bolt, and the bolt is the pressing element and is capable of being inserted into a receptacle to deform the elastic element.

19. The replaceable optical module as claimed in claim 16, wherein the pressing element is a turntable and the elastic element is a spring, and the turntable has a fixed shaft.

20. The replaceable optical module as claimed in claim 16, wherein the connection mechanism is a transverse pin including two fixed holes arranged at intervals and a pin member, and the pin member is the pressing element and is capable of being inserted into the fixed holes to press the elastic element.

21. The replaceable optical module as claimed in claim 16, wherein the pressing element is a camshaft, both ends of the camshaft are capable of being fitted into two fixed holes, and the camshaft is capable of being rotated to press the elastic element.

22. The replaceable optical module as claimed in claim 16, wherein the connection mechanism is a fixed latch including a fixed part and a latch part, the fixed part is fixed on the module interface, one end of the latch part is fixed on the structural casing, the latch part includes a pivot axle, a handle and a support rod, the support rod is the elastic element, and the handle is capable of being rotated around the pivot axle to deform the support rod.
